(19) United States
(12) Patent Application Publication
(10) Pub. No.: US 2011/0310620 A1
(43) Pub. Date: Dec. 22, 2011

(54) TRANSPARENT OPTICAL ELEMENT AND INDICATOR LIGHT HAVING THE SAME

(75) Inventors: Chen-Chia Huang, Hsinchu (TW); Wen-Chih Yeh, Hsinchu (TW)

(73) Assignee: WISTRON NEWEB CORPORATION, Hsinchu (TW)

(21) Appl. No.: 12/818,104

(22) Filed: Jun. 17, 2010

(51) Int. Cl. F21V 5/00; G02B 3/02; G02B 3/00

(52) U.S. Cl. 362/311.06; 359/708; 359/642

(57) ABSTRACT

Disclosed herein is a transparent optical element for changing a propagation direction of light. The transparent optical element includes a light-receiving surface and a light-emitting surface. The light-receiving surface is formed thereon with a first recess having a bottom surface and a second recess located thereon. The second recess has a lateral surface connected to the bottom surface such that a first angle of about 90 degrees to less than 180 degrees is formed between the bottom surface and the lateral surface. An indicator light comprising the transparent optical element is also disclosed.

### BACKGROUND

1. Field

The present invention relates to a transparent optical element for changing a propagation direction of light.

2. Description of Related Art

Indicator lights have been widely used in electronic or electric device to exhibit the status of the device. In general, the indicator lights employ a light emitting diode (LED) that protrudes from the outer surface of the electronic device because a wider visible angle is required. However, in some applications such as portable electronic devices, the protrusive indicator light may be damaged due to the collision. And thus, this kind of indicator lights is not suitable for the portable electronic devices.

Some indicator lights have been designed to resolve the above-mentioned problem. For example, an indicator light that has a top surface positioned at a level substantially the same as the surface of the device has been developed. Unfortunately, this kind of indicator light may not provide a wider visible region. When one observer or user is positioned at a larger viewing angle with respect to the perpendicular direction of the top surface of the indicator light, the observer or user may not correctly distinguish whether the indicator light is in the status of lighting or deem. Therefore, the user may be misdirected by the indicator light.

### SUMMARY

According to one aspect of the present disclosure, a transparent optical element for changing a propagation direction of light is provided. The transparent optical element comprises a light-receiving surface and a light-emitting surface. The light-receiving surface is formed thereon with a first recess having a bottom surface and a second recess located thereon. The second recess has a lateral surface connected to the bottom surface such that a first angle of about 90 degrees to less than 180 degrees is formed between the bottom surface and the lateral surface.

According to one aspect of the present disclosure, an indicator light is disclosed. The indicator light comprises a housing, a light emitting device and a transparent optical element as described above. The housing has an outer surface and an opening located thereon. Both the light emitting device and transparent optical element are disposed in the housing. The light-emitting surface of the transparent optical element is positioned in the opening and at a level substantially the same as or lower than the outer surface. The light-receiving surface of the transparent optical element is operable to receive a light emitted from the light emitting device.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a top view schematically illustrating a transparent optical element according to one embodiment of the present disclosure;

FIG. 2 is a cross-sectional view taking along line 2-2′ in FIG. 1;

FIG. 3 is a cross-sectional view schematically illustrating an indicator light according to another embodiment of the present disclosure;

FIG. 4 is a cross-sectional view schematically illustrating an indicator light according to still another embodiment of the present disclosure; and

FIG. 5 is a cross-sectional view schematically illustrating a transparent optical element according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

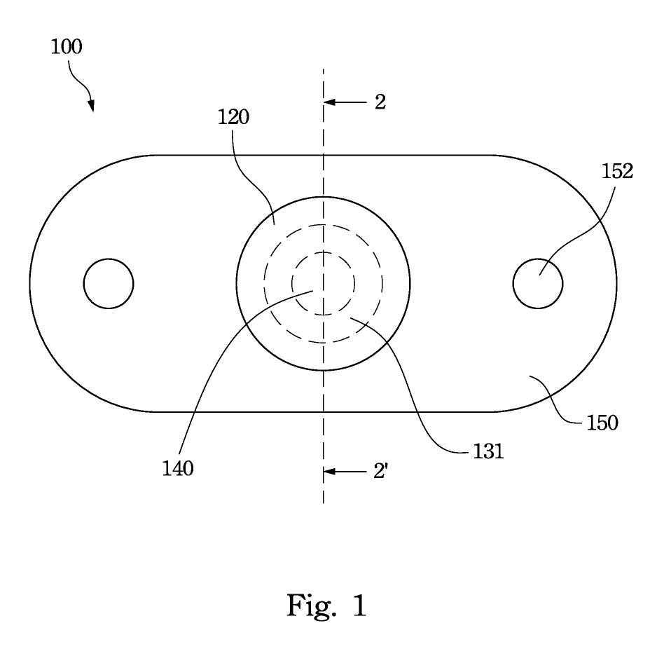

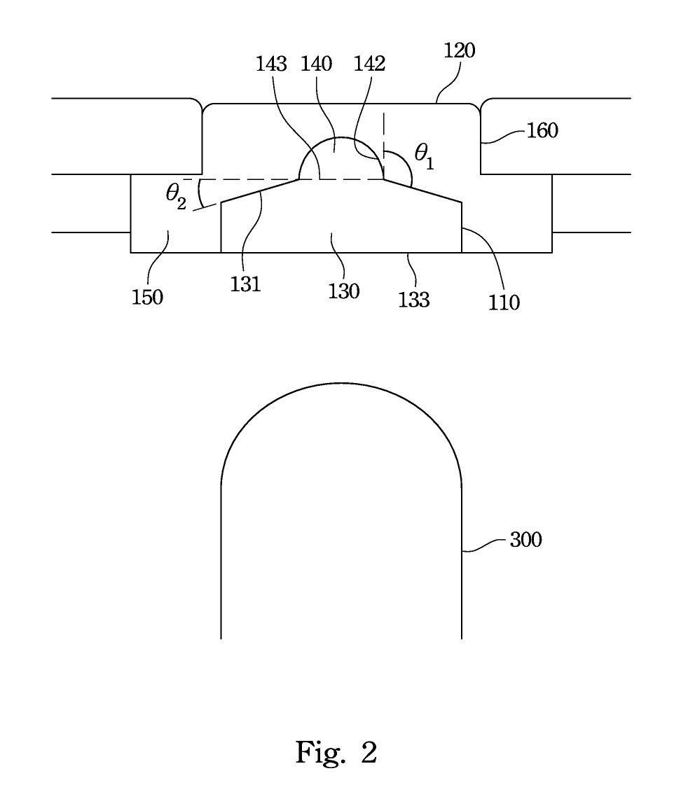

FIG. 1 is a top view schematically illustrating a transparent optical element 100 according to one embodiment of the present disclosure. FIG. 2 is a cross-sectional view taking along line 2-2′ in FIG. 1. The transparent optical element 100 is used for changing a propagation direction of an incident light. Referring to FIG. 1 and FIG. 2, the transparent optical element 100 comprises a light-receiving surface 110 and a light-emitting surface 120. The incident light may transmit to the light-receiving surface 110, and then exits out of the transparent optical element 100 from the light-emitting surface 120. In general, the light-emitting surface 120 is opposite to the light-receiving surface 110.

The light-receiving surface 110 of the transparent optical element 100 is formed thereon with a first recess 130 having a bottom surface 131 and a second recess 140 located on the bottom surface 131. The second recess 140 has a lateral surface 142 connected to the bottom surface 131 such that a first angle θ1 of about 90 degrees to less than 180 degrees is formed between the bottom surface 131 and the lateral surface 142. In one example, the first angle θ₁ is about 90 degrees to about 150 degrees. For instance, the first angle θ₁ may be 92 degrees, 100 degrees, 120 degrees or 140 degrees.

In one embodiment, the bottom surface 131 of the first recess 130 may be an inclined surface such that a second angle θ₂ of less than 90 degrees is formed between the inclined surface and the light-emitting surface 120, as depicted in FIG. 2. In one example, the light-emitting surface 120 is substantially a flat surface and the second angle θ₂ is about 5 degrees to about 45 degrees.

In another embodiment, the second recess 140 has a curvilinear shape being extended from an area connected to the bottom surface 131 of the first recess 130. For instance, the second recess 140 may be shaped of a hemisphere, cone or others. In one example, the first and second recesses 130, 140 respectively have a first inlet 133 and a second inlet 143, and both the first and second inlets 133, 143 are circular in shape. In this example, the diameter of the first inlet 133 is greater than the diameter of the second inlet 143.

In still another embodiment, the transparent optical element 100 is made of a material having a refractive index of about 1.4 to about 1.6. For example, the refractive index may be about 1.45, about 1.5, or about 1.56. In this embodiment, the transparent optical element 100 may be made from polycarbonate, polymethylmethacrylate (PMMA), acrylonitrile butadiene styrene (ABS) or acrylic resin.

In some embodiments, the transparent optical element 100 may further comprises a positioning member 150, which is extended from a side surface 160 of the transparent optical element 100. The transparent optical element 100 may be attached to or fastened onto another article (not shown) by the positioning member 150. In one example, the positioning member 150 may have at least one opening 152, as illustrated in FIG. 1. A tenon of another article (not shown) may pass through the opening 152, and thus the transparent optical element 100 may be fastened onto the article.

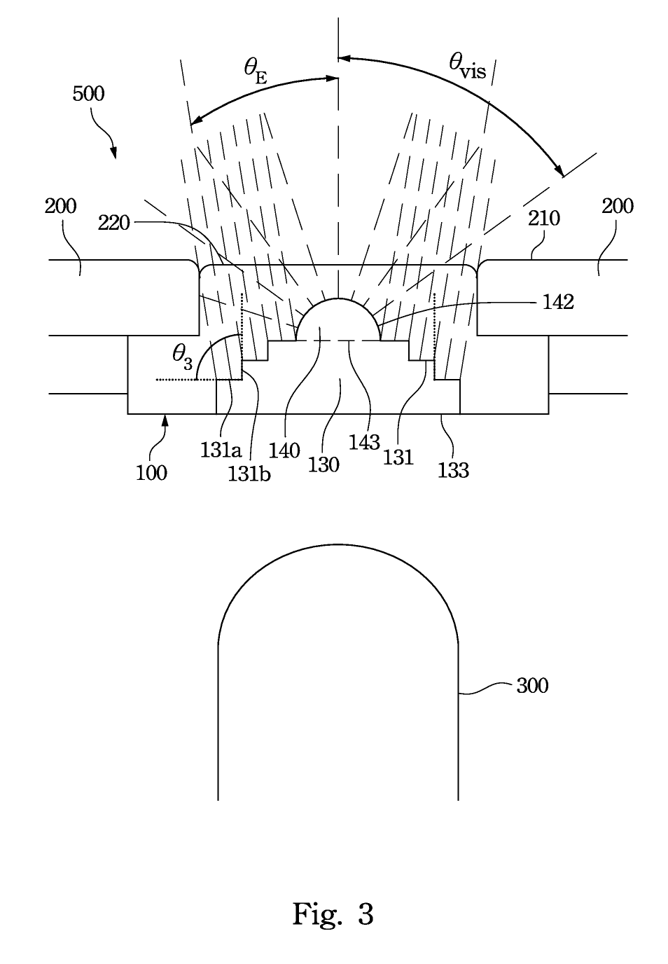

FIG. 3 is a cross-sectional view schematically illustrating a transparent optical element 100 according to another embodiment of the present disclosure. In this embodiment, the bottom surface 131 of the first recess 130 comprises a step-like surface. The term “step-like surface” herein refers to a surface comprising at least one first surface and at least one second surface connected thereto wherein the angle between the first and second surfaces is greater than 90 degrees but less than 180 degrees. In one example, as illustrated in FIG. 3, the step-like surface comprises at least one first surface 131a and at least one second surface 131b, and a third angle θ₃ of about 90 degrees to about 150 degrees is formed between the first and second surfaces 131a, 131b. More specifically, the third angle θ₃ may in the range of 91° to 120°, for example, 92°, 100°, or 115°. In this embodiment, the second recess 140 has a curvilinear shape being extended from an area connected to the bottom surface 131 of the first recess 130. For example, the second recess 140 may be shaped of a hemisphere, cone or the like. In one example, the first and second recesses 130, 140 respectively have a first inlet 133 and a second inlet 143, and both the first and second inlets 133, 143 are circular in shape. The diameter of the first inlet 133 is greater than the diameter of the second inlet 143. In another example, the area of the first inlet 133 is about 65-95 percent of the light-emitting surface 120, and the area of the second inlet 143 is about 25-65 percent of the light-emitting surface 120.

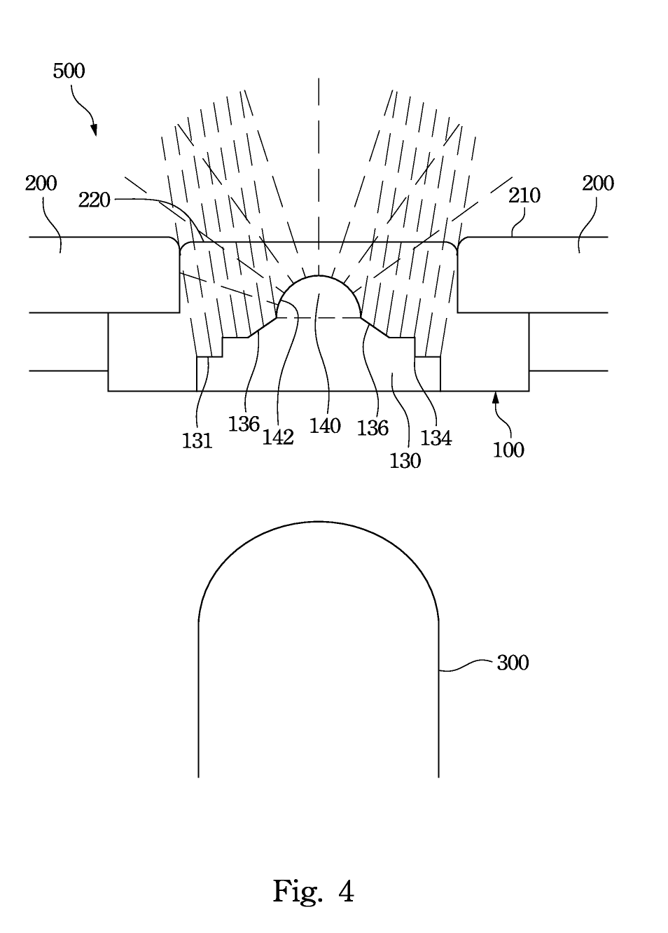

FIG. 4 is a cross-sectional view schematically illustrating a transparent optical element 100 according to still another embodiment of the present disclosure. In this embodiment, the bottom surface 131 of the first recess 130 comprises a step-like surface 134 and an inclined surface 136 connected thereto. In one example, the lateral surface 142 of the second recess 140 is connected to the inclined surface 136, as depicted in FIG. 4. However, one skilled in the art may realize that the lateral surface 142 of the second recess 140 may be connected to the step-like surface while the step-like surface is arranged adjacent to the second recess 140.

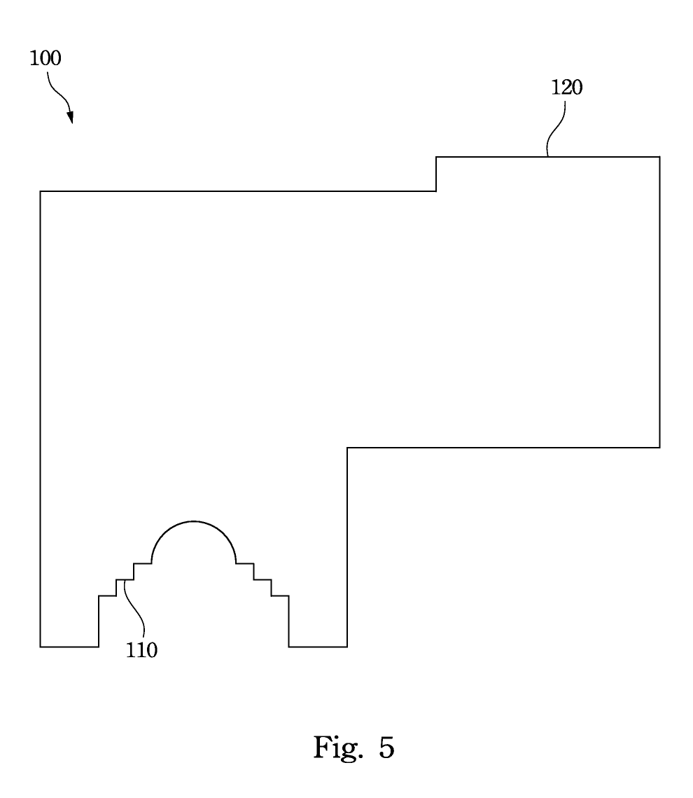

FIG. 5 is a cross-sectional view schematically illustrating a transparent optical element 100 according to still another embodiment of the present disclosure. In this embodiment, the transparent optical element 100 may function as a light guide. The transparent optical element 100 comprises a light-receiving surface 110 and a light-emitting surface 120. The light-receiving surface 110 may be any example as described hereinbefore. In this embodiment, the light transmitted from the light-receiving surface 110 may be propagated in the transparent optical element 100 and then be directed to the light-emitting surface 120.

According to another aspect of the present disclosure, an indicator light is provided. Referring back to the FIG. 2, FIG. 3, FIG. 4A, and FIG. 4B. The indicator light 500 comprises a transparent optical element 100 as described hereinbefore, a housing 200 and a light emitting device 300. The housing 200 has an outer surface 210 and an opening 220 located thereon. The transparent optical element 100 and the light emitting device 300 are disposed in the housing 200. The light-emitting surface 120 of the transparent optical element 100 may be positioned in the opening 220 and at a level substantially the same as or lower than the outer surface 210. The light-receiving surface 110 of the transparent optical element 100 is operable to receive a light emitted from the light emitting device 300.

The light emitted from the light emitting device 300 may transmit into the transparent optical element 100 through the light-receiving surface 110, which is formed thereon with the first and second recesses 130, 140. The surface of the first and second recesses 130, 140 may provide different refractive angle to the incident light, and thus the light emitted from the light emitting device 300 may be directed to different directions. As a result, the visible angle of the indicator light 500 may be increased. The term “visible angle” herein means that an observer can correctly distinguish whether the indicator light being in the state of “ON” or “OFF” within the range of the visible angle, which is also identified as θᵥᵢₛ in FIG. 3. Accordingly, the indicator light disclosed herein may provide a larger visible angle.

In one embodiment, the second recess 140 has a curvilinear shape such as a hemisphere, cone or the like, whereas the first recess comprises an inclined bottom surface, a step-like bottom surface, or both the inclined and step-like surfaces, respectively depicted in FIG. 2, FIG. 3, and FIG. 4. In this embodiment, referring to FIG. 3, a portion of the incident light may be refracted by the curvilinear surface of the second recess 140, and results in a wider visible angle. Simultaneously, another portion of the incident light may be refracted by the inclined or step-like surface of the first recess 130, and thus be directed to certain directions. Therefore, within the certain range of the viewing angle θ_{E}, the brightness of the indicator may be enhanced. The enhanced viewing angle θ_{E} may be adjusted by modifying the bottom surface 131 of the first cress 130, for example, the first angle θ₁, second angle θ₂ and the third angle θ₃. In still another embodiment, the area of the first inlet 133 is about 65-95 percent of the light-emitting surface 120, for example, 75% or 85%, and the area of the second inlet 143 is about 25-65 percent of the light-emitting surface 120, for example, 35% or 50%.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A transparent optical element for changing a propagation direction of light, the transparent optical element comprising a light-receiving surface for receiving the light and changing the propagation direction thereof and a light-emitting surface, wherein the light-receiving surface is formed thereon with a first recess having a bottom surface and a second recess located thereon, and wherein the second recess has a lateral surface connected to the bottom surface such that a first angle ranging from about 90 degrees to less than 180 degrees is formed between the bottom surface and the lateral surface.

2. The transparent optical element according to claim 1, wherein the first angle ranges from about 90 degrees to about 150 degrees.

3. The transparent optical element according to claim 1, wherein the bottom surface comprises an inclined surface such that a second angle of less than 90 degrees is formed between the inclined surface and the light-emitting surface.

4. The transparent optical element according to claim 3, wherein the second angle ranges from about 5 degrees to about 45 degrees.

5. The transparent optical element according to claim 1, wherein the bottom surface comprises a step-like surface.

6. The transparent optical element according to claim 5, wherein the steps-like surface comprises a first surface and a second surface connected thereto so as to form a third angle ranging from about 90 degrees to about 150 degrees between the first and second surfaces.

7. The transparent optical element according to claim 1, wherein the second recess has a hemisphere shape.

8. The transparent optical element according to claim 1, wherein the first and second recesses respectively have a first inlet and a second inlet, and both the first and second inlets are circular in shape.

9. The transparent optical element according to claim 8, wherein the diameter of the first inlet is greater than the diameter of the second inlet.

10. The transparent optical element according to claim 9, wherein the light-emitting surface is substantially flat.

11. The transparent optical element according to claim 10, wherein the area of the first inlet is about 65 percent to about 95 percent of the light-emitting surface.

12. The transparent optical element according to claim 10, wherein the area of the second inlet is about 25 percent to about 65 percent of the light-emitting surface.

13. The transparent optical element according to claim 1, wherein the transparent optical element is made of a material having a refractive index of about 1.4 to about 1.6.

14. The transparent optical element according to claim 1 wherein the transparent optical element comprises a material selected from the group consisting of polycarbonate, polymethylmethacrylate, acrylonitrile butadiene styrene and acrylic resin.

15. The transparent optical element according to claim 1, further comprising a positioning member extended from a side surface of the transparent optical element.

16. An indicator light, comprising:
a housing having an outer surface and an opening located thereon;
a light emitting device disposed in the housing;
a transparent optical element set forth in claim 1 disposed in the housing,
wherein the light-emitting surface of the transparent optical element is positioned in the opening and at a level substantially the same as or lower than the outer surface, and the light-receiving surface of the transparent optical element is operable to receive a light emitted from the light emitting device.

17. The indicator light according to claim 16, wherein the light-emitting surface of the transparent optical element is substantially flat.

18. The indicator light according to claim 16, wherein the bottom surface comprises an inclined surface such that a third angle of about 5 degrees to about 45 degrees is formed between the inclined surface and the light-emitting surface.

19. The indicator light according to claim 16, wherein the bottom surface of the first recess comprises a step-like surface, the second recess has a curvilinear shape being extended from an area connected to the bottom surface.

20. The indicator light according to claim 16, wherein the first recess has a first inlet, and the area of the first inlet is about 65 percent to about 95 percent of the light-emitting surface.
